(19) United States
(12) Patent Application Publication
(10) Pub. No.: US 2007/0134494 A1
(43) Pub. Date: Jun. 14, 2007

(54) Cubic boron nitride sintered body and method for making the same

(76) Inventors: Stephen L. Dole, Columbus, OH (US); Steven W. Webb, Worthington, OH (US); James M. McHale Jr., Worthington, OH (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/595,737

(22) PCT Filed: Dec. 3, 2004
(86) PCT No.: PCT/US04/40291

§ 371 Date: May 8, 2006

Related U.S. Application Data
(60) Provisional application No. 60/526,576, filed on Dec. 3, 2003.

(51) Int. Cl. C04B 35/583; B32B 5/16

(52) U.S. Cl. 428/403; 501/96.4; 501/127

(57) ABSTRACT

A cubic boron nitride sintered body is provided having improved strength and hardness for serving as a cutting tool. The sintered body includes cBN dispersed in a binder material, wherein the binder includes alumina, at least one other aluminum compound, and a non-aluminum material such as a carbide, nitride, carbonitride, boride or silicide of Groups IVa, Va, and VIa of the periodic table, or a mixture thereof.

### CLAIM OF PRIORITY

This application claims priority to U.S. Provisional Patent Application No. 60/526,576, filed Dec. 3, 2003, entitled “Cubic Boron Nitride Sintered Body and Method for Making the Same,” which is incorporated herein by reference in its entirety.

### TECHNICAL FIELD

The present invention relates to a cubic boron nitride sintered body. In particular, the invention relates to a cubic boron nitride sintered body with improved wear resistance, as well as a method of preparing the same.

### BACKGROUND

Polycrystalline cubic boron nitride-based (PCBN) compacts sintered under high pressure and high temperature are known. Sintered bodies for use in cutting tools may be prepared by high pressure/high temperature (BP/HT) sintering of cubic boron nitride (cBN) powder with a binder phase. The binder phase may be comprised of ceramic materials such as TiN, TiC, TiB₂, AlN, AlB₂, or the like. The binder phase, although lower in hardness and abrasion resistance than cBN, may improve the performance of the compact or tool by reducing the amount of adhesive or chemical wear that occurs during a machining operation.

Cast irons, such as ductile irons, nodular irons, compacted graphite irons, grey cast irons, and spin-cast grey irons, and in particular compacted graphite irons, nodular irons, and ductile irons, may be very difficult materials to machine. PCBN tool materials are often not economical in some of these cast iron compact applications. In addition, the lifetime and wear resistance of PCBN tools may not be substantially greater than those of conventional abrasive materials (e.g., cemented carbides, TiC-Al₂O₃ ceramics, and similar hard materials). It is believed that the high temperatures generated at the cutting point in some cast iron machining applications leads to a chemical reaction between the iron and cBN grains in the PCBN. However, the use of conventional tool materials generally requires a lower machining speed than is achievable with a PCBN tool. Not incorporating PCBN into a tool thus may result in lost productivity, lower throughput, and a higher overall part cost. Therefore, it is desirable to fabricate tools for machining cast irons comprising PCBN particles. It is possible that an optimized binder composition would limit the reaction between the cBN particles while enabling high processing speeds.

Therefore, in the art, there has been a focus to combine optimum superabrasive and binder materials in a compact composition. For example, JP Patent Publication No. 07-082031, herein incorporated by reference in its entirety, discloses a cBN sintered compact consisting of 10-70 vol. % cBN in a binding phase consisting of 5-30 vol. % of alumina (aluminum oxide) with particle diameter of 1 micron or less, 3-20 vol. % of aluminum nitride/boride; 10-40 vol. % of Ti carbide/nitride, and 3-20 vol. % of Ti boride. The cBN particles have a particle size of 4 microns.

In another reference, JP Patent Publication No. 08-126903, herein incorporated by reference in its entirety, a cBN sintered body with improved wear resistance is disclosed. This cBN sintered body comprises 20-40 vol. % of Ti carbide/nitride, 1-5 vol. % of aluminum nitride, 3-10 vol. % of Ti boride, 3-15 vol. % of aluminum oxide, with the residual consisting of cBN, and wherein at least 60% of the surface areas of the cBN grains are mutually bonded. The cBN has a particle diameter of 1-3.5 microns, while the TiC powder has a particle diameter of 0.5-1.8 microns.

U.S. Pat. No. 5,690,706, herein incorporated by reference in its entirety, discloses a cBN sintered compact wherein the ceramic binder consists of nanosized particles, and wherein the sintering of the compact is carried out at a relatively low pressure of less than 10 Kbar. In U.S. Pat. No. 3,852,078, herein incorporated by reference in its entirety, a tool material is disclosed, wherein the initial sinter mixture contains hexagonal boron nitride and diamond particles. U.S. Pat. No. 5,328,875, herein incorporated by reference in its entirety, discloses a cBN sintered tool material, wherein the cBN grains are bonded with aluminum and titanium compounds including aluminum oxide, and wherein the grain sizes of all phases are less than 1 micron.

There is a need for an improved sintered compact of cBN and a binder phase that can be used to machine ferrous metals such as cast iron, compacted graphite iron, and ductile/nodular iron. Optimization of the cBN and binder phases will allow for high processing speeds, appropriate toughness, without damaging side reactions. The present invention is directed to solving one or more of the problems described above.

### SUMMARY

One embodiment of the present invention relates to a cubic boron nitride sintered body having improved wear resistance against ferrous materials for serving as a cutting tool. A sintered compact may comprise: about 10 to about 50 vol. % of cBN particles, about 30 to about 50 vol. % of aluminum oxide, about 1 to about 25 vol. % of aluminum or an aluminum compound other than the aluminum oxide, and at least one material selected from the group consisting of carbides, nitrides, carbonitrides, borides and silicides of Groups IVa, Va, and VIa of the periodic table. The cBN particles may be dispersed within the other compact materials. In an embodiment, the cBN particles may have a size of at least about 1 micron, while the aluminum oxide may have a particle size of about 0.1 to about 5 micron.

In an embodiment, a method of making a sintered compact may include the step of preparing a substantially homogeneous powder mixture comprising cBN particles, alumina particles, and a source of metallic aluminum, with the remainder comprising at least one material selected from the group consisting of carbides, nitrides, carbonitrides, borides and silicides of Groups IVa, Va, and VIa of the periodic table, mixtures thereof. The method may also include sintering the mixture into a coherent body at a pressure of at least about 3 GPa and a temperature above about 1000° C.

In an embodiment, the invention further relates to the application of sintered compacts in machining nodular irons, compacted graphite irons, grey cast irons, white cast irons, ductile irons, and/or spin-cast grey irons.

### BRIEF DESCRIPTION OF THE DRAWING

FIG. 1 is a scanning electron microscope (SEM) photograph of one embodiment of a cBN sintered compact.

### DETAILED DESCRIPTION

Before the present compositions and methods are described, it is to be understood that this invention is not limited to the particular processes, compositions, or methodologies described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an”, and “the” include plural references unless the context clearly dictates otherwise. Thus, for example, reference to a “powder” is a reference to one or more powders and equivalents thereof known to those skilled in the art, and so forth.

Unless defined otherwise, all technical and scientific terms used herein have the same meanings as commonly understood by one of ordinary skill in the art. Although any methods and materials similar or equivalent to those described herein may be used in the practice or testing of embodiments of the present invention, the preferred compositions, methods, devices, and materials are now described. All publications mentioned herein are incorporated by reference in their entirety. Nothing herein is to be construed as an admission that the invention is not entitled to antedate such disclosure by virtue of prior invention.

A sintered body of cubic boron nitride (cBN) with an optimized composition of cBN powder in a binder displays improved performance in machining ferrous materials at high cutting speeds. The body may have an optimized composition of cBN powder in a binder comprising alumina, aluminum and/or aluminum compounds, and the remainder comprising carbides, nitrides, or borides of metals of Groups IV-VI of the periodic table, and mixtures thereof.

Particles of cBN in a sintered compact or tool may impart properties of wear resistance and chipping resistance. Particles of cBN may comprise about 10 to about 70 volume percent of the total compact volume. In an embodiment, cBN particles are present in the compact an amount of about 10 to about 50 volume %. In another embodiment, cBN particles may be present in an amount of about 15 to about 25 vol. %. As used herein, “cBN” may refer to cubic boron nitride, wurtzitic boron nitride, or mixtures thereof.

Particles of cBN may have an average grain size of at least about 1 micron. In an embodiment, the cBN particles have an average grain size of less than about 50 microns. Finer-grained compacts may provide greater impact resistance while performing in aggressive cutting applications, and may provide smoother surfaces in finishing applications. For example, a cBN grain size of less than about 30 microns may be used. In yet another embodiment, the cBN has an average particle size of about 1 to about 15 microns. Particle size may be measured by any suitable means, such as by a light scattering technique.

In one embodiment, the cBN particles may be a mixture of uncoated cBN and coated cBN particles, or solely cBN particles coated with at least a layer of coating. In an embodiment, the coating may have a thickness of about 1 to about 50 μm, although other thicknesses are possible. Coatings may provide heat-resistance, such as to protective any unwanted reaction between the cBN and the iron workpiece being machined. Such a coating may be a metal coating. When there are multiple layers of a coating, some or all layers may be the same, or some or all layers may consist of different materials. In one embodiment, the inner coating layer adjacent to the cBN particle is a material that has a is coefficient of thermal expansion closest to that of cBN, when compared to other layers. The coating may be a multilayer type comprising combinations of any number of layers. Optionally, the coating may be metal nitride, metal carbide, or metal oxide, wherein the metal is preferably a metal from Groups IVa to VIa of the Periodic Table. Such compounds are generally known as carbide-forming metals and include the materials comprised of chromium, tungsten, titanium, tantalum, zirconium, molybdenum, hafnium, vanadium, silicon, niobium, alloys thereof, or a carbide, boride, or nitride thereof.

To coat the cBN particles, any suitable method of coating may be used, such as a vapor phase deposition technique, and specifically a chemical vapor deposition technique. For example, any of the methods described in U.S. Pat. No. 6,475,254, herein incorporated by reference in its entirety, may be used to coat the cBN particles. In an embodiment, the materials used to coat the cBN particles may include those that are already found within the described compact composition ranges. In other words, in an embodiment, the coating provides a way of forming the cBN compact, not an additional component. In an embodiment, instead of providing a uniform powdered mixture of the compact materials (cBN, alumina, another aluminum based material, and a non-aluminum based material), non-cBN components may be provided in whole or in part to the cBN particles as a coating.

Other materials for one or more coating layers may include alumina (Al₂O₃). The coating may also comprise carbide formers or coating materials which form borides or nitrides. Examples of suitable metals for coating cubic boron nitride include tin, lead, antimony, or nitrides thereof; cobalt; tungsten; titanium; zirconium; hafnium; vanadium; niobium; tantalum: chromium; molybdenum; nickel; tungsten; or a carbide, boride, nitride, or oxide thereof. The coating may be of high adhesive strength, containing at least one layer of at least one element selected from the group consisting of Groups Iva, Va, VIa elements, Al, B, Si and Y. Other coatings may be comprised of at least one element selected from the Groups consisting of C, N and O and having a hardness of a Knoop Hardness Hk of at least 2,000 and a film thickness of at least 0.5 μm to 10 μm. Other materials and thicknesses may be suitable for coating cBN particles.

A sintered compact or tool may include a binder material. A binder material is generally thought of as all the components other than a superabrasive. The binder phase provides hardness and toughness, while minimizing the tendency for chemical reaction with the workpiece under the high temperatures generated at the cutting point during a typical machining operation. A suitable binder material may include, for example: (i) aluminum oxide (alumina); (ii) aluminum or an aluminum compound other than the aluminum oxide; and (iii) at least one non-aluminum binder material.

Non Aluminum Binder Materials. Examples of non-aluminum binder materials for use in a sintered compact may include selected carbides, nitrides, carbonitrides, borides and suicides of Group IVa (for example, Ti, Zr, Hf), Group Va (for example, V, Nb, Ta) and Group VIa (for example, Cr, Mo, W). The non-aluminum binder material may be a mixture of any of these materials, as well as a solid solution of one or more of these compounds. The non-aluminum binder material may provide a high hardness value, a high welding value, suitable metallic properties for the sintered compact. The non-aluminum binder material may have a grain size of greater than about 1 micron. Particularly, the heat conductivity of a non-aluminum binder may exhibit a value similar to metals. Preferably, the non-aluminum binder material is selected from one of titanium nitride, titanium boride, titanium carbide, and titanium carbo-nitride. Preferably, the non-aluminum binder material may be about 1 to about 60 vol. % of the compact, although other ranges are possible.

Alumina. The binder phase may also comprise alumina. The alumina may be about 25 to about 50 vol. % of the compact, more preferably over 30 and up to about 50 vol. % of the compact, although other ranges are possible. The alumina may help to extend the life of tools used to machine ferrous materials. As alumina is known to be an inert material, it may reduce the tendency for chemical reaction of the tool material with the workpiece under the high temperatures generated at the cutting point during a typical machining operation. Suitable alumina for the binder phase may include, for example, bauxite (including both natural occurring bauxite and synthetically produced bauxite), calcined bauxite, hydrated alumina (e.g., boehmite, and gibbsite), Bayer® process alumina, aluminum ore, gamma alumina, alpha alumina, aluminum salts, aluminum nitrates, and combinations thereof. The alumina source may contain Al₂O₃, as well as one or more metal oxides other than Al₂O₃ (including materials of or containing complex Al₂O₃ metal oxides (for example, Dy₃Al₅O₁₂, Y₃Al₅O₁₂, CeAl₁₁O₁₈). In one embodiment, the alumina may be in powder form, having an average particle size of about 0.1 micron up to about 50 micron, preferably about 0.1 to about 5 micron.

Other Al Components. In addition to the alumina, the compact may also include another aluminum containing material. The other aluminum containing material may be a metallic aluminum or aluminum compounds such as aluminum boride, aluminum nitride, CoAl₃, and (Co, Ni)Al₃. The aluminum containing material may comprise about 1 to about 25 vol.% of the compact, preferably about 1 to 5 vol. %, although other ranges are possible

The cBN particle and the binder phase (other constituents) may be mixed prior to sintering. The aluminum compounds may be added directly to the powder mix before sintering. Alternatively, the powder mix may contain a source of metallic aluminum, which under high pressure and high temperature sintering, will melt and react with the cBN and other binder phases to produce aluminum compounds (for example, AlN, AlB₂, TiAlN). Some portion of metallic aluminum may be added to the powder mix in metallic form, such that the transient liquid aluminum that results during the sintering process fills pores within the powder bed and provides for a more homogeneous sintered compact. Metallic aluminum may added to the powder mix, for example, in the range of about 3 to about 15 vol %. The source of metallic aluminum may be NiAl₃, which may be added to the powder mix, for example, in the range of about 5 to about 20 vol %. Alternatively, as discussed with reference to a coating layer on the cBN particles, non-cBN based materials may be added first as a coating, and then other or similar materials may be provided as a uniform powder.

In forming a sintered compact, the powdered mix may be sintered and integrally formed onto a substrate material. Suitable substrates may include a metal carbide selected from the group consisting essentially of Group IVB, Group VB, and Group VIB metal carbides, such as tungsten carbide. The sintered compact may also include some impurity such as tungsten carbide debris that results from the milling operations. In some embodiments, the impurity amount may range from less than 1 to about 15 wt. % of the total mixture of the compact.

Sintered compacts may be formed according to any suitable process. In one embodiment, a wet type pulverized mixing of the respective powders, e.g., binder materials and cBN, may be carried out in a ball mill for a sufficient period of time to obtain a mixture with the cBN and alumina being incorporated as a homogenously distributed within the mixture. In one example, the wet blending is carried out for about 30 minutes to about 72 hours. In a second example, the ball milling may be accomplished in a steel mill using tungsten carbide milling media, with a non-reactive liquid such as a light alcohol that acts as a milling fluid, for a period of about 1 to about 12 hours. Surfactants may be added to the milling fluid to improve the mixing and dispersion of cBN in the binder phase. Other mixing techniques are possible.

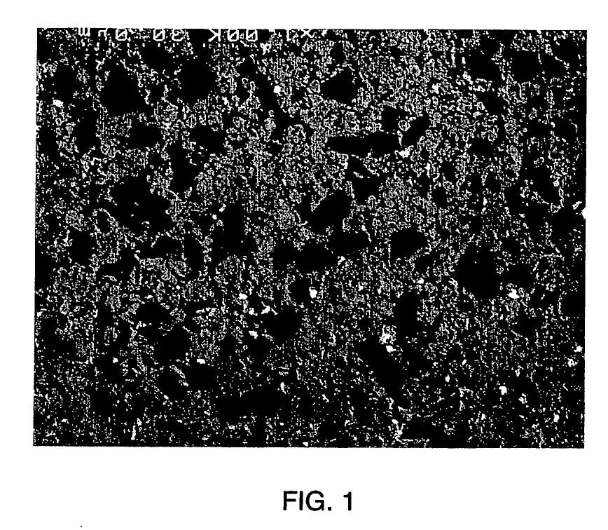

The mixture may be blended such that the cBN grains are dispersed, preferably in homogenous or a substantially homogenous manner, in the binder phase with little cBN to cBM bonding or contact, such as is illustrated in FIG. 1. FIG. 1 is a SEM (scanning electron microscope) image of a sintered compact, measured from a polished cross-section of the compact, wherein less than 20% of the cBN grains have grain-to-grain bonding contact. FIG. 1. also shows that the cBN grains may be homogenously distributed in the mixture (black grains in the structure) with very little grain to grain contact at the grain boundary. Also visible is the relative size of the cBN grains and the binder material, wherein both particles are at least about 1 micron in size. Preferably, the cBN grains are slightly larger in diameter than the binder powders. The higher the volume percentages of cBN in the sintered compact, the more difficult it may be to disperse the cBN in the binder phase well enough to minimize cBN-cBN grain contact. When cBN volume percentages approach about 60%, coating of the cBN grains with binder materials, as discussed above, may ensure that cBN grain contact is minimized.

After mixing the cBN particle and binder phase, the mixture may be dried and press-formed to form semi-dense compacts having dimensions ranging from about 1 to about 15 mm thick, and about 10 to about 80 mm diameter. In an embodiment, the pressed powder bodies and containment materials may be then placed together in a high pressure sintering apparatus and sintered, preferably at a pressure of at least about 3 GPa and a temperature of about 1000 to about 1600° C., more preferably about 1000 to about 1400° C., for about 20 to about 60 minutes. The sintered compact may contain cBN grains that are uniformly or substantially uniformly dispersed in the binder phase. In another embodiment, the mixture may be dried and the resulting powder may be loaded into a shallow, flat-bottomed, cup made of a suitable material, such as cemented tungsten carbide. The cup may be covered with a refractory metal disc and sintered at about 1000 to about 1600° C. After the sintering cycle is complete and the cup removed from the high is pressure apparatus, the resulting compact may be machined to form a disc of PCBN supported on a tungsten carbide substrate. In yet another embodiment, the cup may be made of a refractory metal and a tungsten carbide disc forms the covering lid. This arrangement may similarly be used for fabrication of PCBN in a tungsten carbide supported form.

Specimens may be machined via processes known in the art to form suitable tools. Machining may include electrical discharge machining, electrical discharge grinding, or other processes, into a desired shape. Suitable shapes include a 80° triangle, forming a tip to use in various cutting, machining, and drilling applications.

An optimized sintered compact may be about 15 to about 25 vol. % cBN, about 30 to about 50 vol. % alumina (aluminum oxide), about 1 to about 25 vol. % of a non-aluminum binder material selected from carbides, nitrides, carbonitrides, borides and silicides of IVa (Ti, Zr, Hf), Va (V, Nb, Ta) and VIa (Cr, Mo, W) group transition metals of the periodic table and mixtures thereof, and about 1 to about 25 vol. % of metallic aluminum, aluminum compounds, or mixtures thereof.

### EXAMPLES

In tests employing cutting tools fabricated from the sintered compacts having the optimized composition of the present invention, the tools have been found to outperform tools employing sintered compacts of the prior art in machining cast irons at high speeds in either a continuous or interrupted cutting mode. The example described below is merely representative of the work that contributes to the teaching of the present invention, and the present invention is not to be restricted by the example that follows.

The compacts of Tables 1 and 2 were formed with cBN having an average particle size of 1-20 microns. The binder constituents had particle sizes ranging from 0.1 to 5 microns. Specifically, the alumina had a particle size of 0.4 microns. The cBN and binder phase was mixed by ball milling in a steel mill using a tungsten carbide milling media with light alcohol as a milling fluid for 1-12 hours. The processed powder mixture was loaded into refractory metal cups (tantalum or niobium). The powder was leveled in the cup and a tungsten carbide substrate was loaded into the cup to enclose the powder within the cup. The blank was then loaded into a high pressure cell and subject to a pressure of 40-55 Kbar and at a temperature of about 1400° C. for 30-40 minutes to sinter the powder mixture and braze the formed compact to the tungsten carbide substrate.

Compacts of 58 mm in diameter and 1.6 mm thick were formed, machined to desired geometry, for example 80° or 35° triangles, brazed into a corner of carbide insert bodies, and used to machine cylinder liners made out of cast iron. Flank wear was measured at a speed of 2200 surface feet/min, a feed rate of 0.10″ per revolution; and 0.02″ depth of cut. Each test was conducted twice and an average number was obtained and reported in the Tables. Flank wear represent the wear depth on the sintered compact (in mil).

In Table 1, the flank wear measurement was taken for the same amount of linear inch machined by 2 different tools, an 80° trigon and a 35° diamond. In this test, the lower the flank wear number, the better the tool performance. The machining was against 10 compacted graphite iron (CGI) cylinder liners. In some of the examples, the compact was coated with a TiC-aluminum oxide coating.

TABLE 1

| | Vol % | Vol % | Vol % | Vol % | Insert | Flank Wear in 0.001″ | |
|---|---|---|---|---|---|---|---|
| Run # | TiC | Alumina | Al | cBN | Status | 80 deg tool | 35 deg tool |
| 2 | 31.875 | 28.125 | 15 | 25 | Uncoated | 5.7 | 7.5 |
| 5 | 29.25 | 32.5 | 3.25 | 35 | Uncoated | 7.5 | 5.6 |
| 7 | 38.25 | 42.5 | 4.25 | 15 | Uncoated | 5.9 | 4.7 |
| 9 | 27 | 11.25 | 6.75 | 55 | Uncoated | 7.2 | 9.2 |
| 11 | 42.5 | 21.25 | 21.25 | 15 | Uncoated | 11.6 | 9.4 |
| 18 | 22.5 | 11.25 | 11.25 | 55 | Uncoated | 13.9 | Broke |
| 26 | 23.375 | 20.625 | 11 | 45 | Uncoated | 14.6 | 12.2 |
| 28 | 54.375 | 9.375 | 11.25 | 25 | Uncoated | 5.6 | 17.8 |
| 33 | 33.75 | 0 | 11.25 | 55 | Coated | 6.4 | Broke |

Machining was conducted on compacted graphite iron (CGI) cylinder liners at speed of 1300 surface feet per minute, a feed rate of 0.016″ per revolution and a depth of cut of 0.06-0.08″. The flank wear data demonstrates that the incorporation of alumina in the tool material provides a superior tool.

In Table 2, additional machining tests were conducted to test the effect of alumina content and cBN content. The test conditions were the same as for Table 1 and a lower flank wear value indicates a better tool.

TABLE 2

| | | Vol % | | Vol % | | |
|---|---|---|---|---|---|---|
| Run # | Vol % TiC | Alumina | Vol % Al | cBN | Insert Status | Flank Wear in 0.001″ |
| 2 | 42.5 | 37.5 | 20 | 25 | Uncoated | 7 |
| 3 | 45 | 50 | 5 | 55 | Uncoated | 10 |
| 5 | 45 | 50 | 5 | 35 | Uncoated | 7 |
| 7 | 45 | 50 | 5 | 15 | Uncoated | 5 |
| 21 | 95 | 0 | 5 | 25 | Uncoated | 13 |
| 24 | 95 | 0 | 5 | 15 | Uncoated | 9 |
| 25 | 25 | 50 | 25 | 55 | Uncoated | 16 |
| 27 | 85 | 0 | 15 | 35 | Uncoated | 18 |

The test data shows that the presence of alumina in the tool material combined with a low vol. % cBN (<50%) may provide a superior tool.

In Table 3, tool performance is expressed as linear inches machined per mil (0.001 inch) of flank wear on the tool. The greater the number of linear inches machined per 0.001″ of flank wear, the better the tool. The machining was against cast iron cylinder liners made using a spin cast process. Cast iron cylinders made via the spin cast process typically wear cBN tools five times faster than cast iron liners made by a conventional process. In this case, machining was carried out at a speed of 2200 surface feet/min., a feed rate of 0.01″ per revolution, and 0.02″ depth of cut.

TABLE 3

| | | | | | Vol % | | Vol % | Linear Inches per |
|---|---|---|---|---|---|---|---|---|
| Blend # | Vol % TiN | Vol % TiC | Vol % WC | Vol % TaC | alumina | Vol % Al | cBN | 0.001″ flank wear |
| 1 | 2.25 | 0 | 15.75 | 0 | 15.75 | 11.25 | 55 | 4854 |
| 4 | 0 | 28 | 0 | 0 | 0 | 7 | 65 | 3806 |
| 5 | 0 | 33.75 | 0 | 0 | 0 | 11.25 | 55 | 3970 |
| 8 | 30 | 0 | 0 | 26.25 | 0 | 18.75 | 25 | 4080 |
| 9 | 0 | 3.75 | 26.25 | 0 | 26.25 | 18.75 | 25 | 5181 |
| 11 | 0 | 33 | 0 | 19.25 | 0 | 2.75 | 45 | 3841 |
| 14 | 0 | 0 | 19.25 | 13.75 | 19.25 | 2.75 | 45 | 5268 |
| 15 | 0 | 48.75 | 0 | 0 | 0 | 16.25 | 35 | 3087 |
| 16 | 37.5 | 0 | 0 | 18.75 | 0 | 18.75 | 25 | 3063 |
| 18 | 27.5 | 5.5 | 0 | 19.25 | 0 | 2.75 | 45 | 4383 |
| 28 | 0 | 8.75 | 0 | 12.25 | 12.25 | 1.75 | 65 | 5246 |
| 31 | 0 | 2.75 | 0 | 19.25 | 19.25 | 13.75 | 45 | 6429 |
| 35 | 0 | 18.75 | 0 | 26.25 | 26.25 | 3.75 | 25 | 6483 |
| 38 | 0 | 16.25 | 22.75 | 0 | 22.75 | 3.25 | 35 | 4804 |

Entries Nos. 1, 9, 14, 28, 31, 25, and 38 represent compositions within the presently described compacts.

In Table 4, an optimal composition derived from the earlier tests, entry No. 3 was tested against several commercially available cutting tool materials, entries Nos. 1-2, 4-6. The approximate composition for each tool material is given. The test conditions are the same as those used for the data in Table 3. The flank wear of each tool is measured and compared to the number of linear inches machined. The slope of the line defined by flank wear vs. linear inches machined was determined for each tool in several tests. The slope was taken at a point where the tool flank wear is relatively linear and constant vs. linear inches machined. The higher the linear inches machined per 0.001″ flank wear, the better the tool.

TABLE 4

| | | | | | | Slope = Linear |
|---|---|---|---|---|---|---|
| | | | | Vol % | | Inches per |
| | | | Vol % | Aluminum | | 0.001″ flank |
| Tool # | Vol % TiN | Vol % TiC | Alumina | Nitride | Vol % cBN | wear |
| 1 | 7 | 4 | 2 | 13 | 74 | 8498 |
| 2 | 0 | 10 | 0 | 15 | 75 | 3502 |
| 3 | 0 | 34 | 40 | 2 | 25 | 72077 |
| 4 | 0 | 40 | 60 | 0 | 0 | 207 |
| 5 | 8 | 0 | 0 | 7 | 85 | 7611 |
| 6 | 0 | 27 | 12 | 6 | 55 | 14947 |

Entry No. 3, having an alumina content of about 40 vol. % and a cBN content of about 25 vol. % exhibited the best tool performance. Sintered compacts having an optimized cBN and binder phase composition thus exhibit excellent wear and performance properties.

While the invention has been described with reference to a preferred embodiment, those skilled in the art will understand that various changes may be made and equivalents may be substituted for elements thereof without departing from the scope of the invention. AU of the patents, patent applications, articles, and texts mentioned above are incorporated herein by reference.

1. A wear resistant sintered compact comprising:
about 10 to about 50 vol. % of cBN particles;
about 30 to about 50 vol. % of aluminum oxide;
about 1 to about 25 vol. % of an aluminum-containing material other than aluminum oxide; and
at least one material selected from the group consisting of carbides, nitrides, carbonitrides, borides and suicides of Groups IVa, Va, and VIa of the periodic table.

2. The sintered compact of claim 1, wherein the cBN particles are uniformly dispersed within the compact.

3. The sintered compact of claim 1, wherein the cBN particles are about 1 to about 15 microns in size.

4. The sintered compact of claim 1, wherein the at least one material in the binder comprises a Group IV metal.

5. The sintered compact of claim 1, wherein the at least one material in the binder comprises TiN, TiC, TiB₂, or TiCN.

6. The sintered compact of claim 1, wherein the aluminum oxide has a particle size of about 0.1 to about 5 microns in size.

7. The sintered compact of claim 1, wherein the compact comprises about 35 to about 45 vol. % of aluminum oxide.

8. The sintered compact of claim 1, wherein the compact comprises about 25 to about 50 vol. % cBN particles.

9. The sintered compact of claim 1, wherein the an aluminum-containing material comprises elemental aluminum, aluminum nitride, aluminum boride, or mixtures thereof.

10. The sintered compact of claim 1, wherein the cBN particles are coated with at least one layer of a carbide forming material.

11. A method for manufacturing a sintered compact comprising:
providing a mixture, wherein the mixture is at least substantially homogenous and comprises:
about 10 to about 50 vol. % cBN particles;
about 30 to about 50 vol. % aluminum oxide;
about 1 to about 25 vol. % of a source of an aluminum-containing material that is not aluminum oxide; and
at least one material selected from the group consisting of carbides, nitrides, carbonitrides, borides and silicides of Groups IVa, Va, and VIa of the periodic table; and
sintering the mixture into a coherent body at a pressure of at least 3 GPa and a temperature above 1000° C.

12. The method of claim 11, wherein the cBN particles are about 1 to about 15 microns in size.

13. The method of claim 11, wherein the at least one material comprises a Group IV metal.

14. The method of claim 11, wherein the at least one material is selected from the group consisting of TiN, TiC, TiB₂, and TiCN.

15. The method of claim 11, wherein the aluminum oxide particles have a particle size of about 0.1 to about 5 microns.

16. The method of claim 11, wherein the mixture comprises about 35 to about 45 vol. % of aluminum oxide.

17. The method of claim 11, wherein the mixture comprises about 25 to about 50 vol. % of cBN particles.

18. The method of claim 11, wherein the cBN particles are coated with at least one layer of a carbide forming material.

19. A method of machining a cast iron material comprising:
machining a surface of a cast iron material with a tool comprising an abrasive body, wherein the abrasive body comprises:
about 10 to about 50 vol. % cBN particles;
about 30 to about 50 vol. % aluminum oxide;
about 1 to about 25 vol. % of an aluminum-containing material compound other than aluminum oxide; and
at least one material selected from the group consisting of carbides, nitrides, carbonitrides, borides and silicides of Groups IVa, Va, and VIa of the periodic table.

20. The method of claim 19, wherein the cast iron material comprises at least one of ductile iron, nodular iron, compacted graphite iron, grey cast iron, and a spin-cast grey iron.
